(19) United States
(12) Patent Application Publication
(10) Pub. No.: US 2016/0346597 A1
(43) Pub. Date: Dec. 1, 2016

(54) IN-FLOOR TREADMILL ASSEMBLY

(71) Applicant: Sean O'Mara, Excelsior, MN (US)

(72) Inventor: Sean O'Mara, Excelsior, MN (US)

(21) Appl. No.: 15/153,049

(22) Filed: May 12, 2016

Related U.S. Application Data
(60) Provisional application No. 62/160,047, filed on May 12, 2015.

(51) Int. Cl. A63B 22/02; A63B 23/035; G06T 19/00; A63B 21/00

(52) U.S. Cl. CPC A63B 22/0235; A63B 21/4035; A63B 23/03516; G06T 19/006; A63B 2225/20

(57) ABSTRACT

A treadmill assembly is provided that is located co-planar with a surrounding floor surface. An edge assembly is provided that spans a gap between the floor surface and the treadmill assembly.

### BACKGROUND

Current treadmills are positioned on top of floors, locating an upper surface of the treadmill above a surface of the floor. This spacing between the upper surface of the treadmill and the surface of the floor presents a potential safety hazard. For example, a person that accidentally trips and falls during use of the treadmill will not only potentially encounter injury from the treadmill, but also the floor due to the distance between the upper surface and the surface of the floor.

### SUMMARY

A treadmill assembly is provided that is located co-planar with a surrounding floor surface. An edge assembly is provided that spans a gap between the floor surface and the treadmill assembly.

### BRIEF DESCRIPTION OF THE DRAWINGS

FIG. 1 is a schematic view of a treadmill assembly.

FIG. 2 is a schematic top view of the treadmill assembly of FIG. 1.

FIG. 3 is a schematic view of a frame assembly for support of a treadmill assembly.

### DETAILED DESCRIPTION

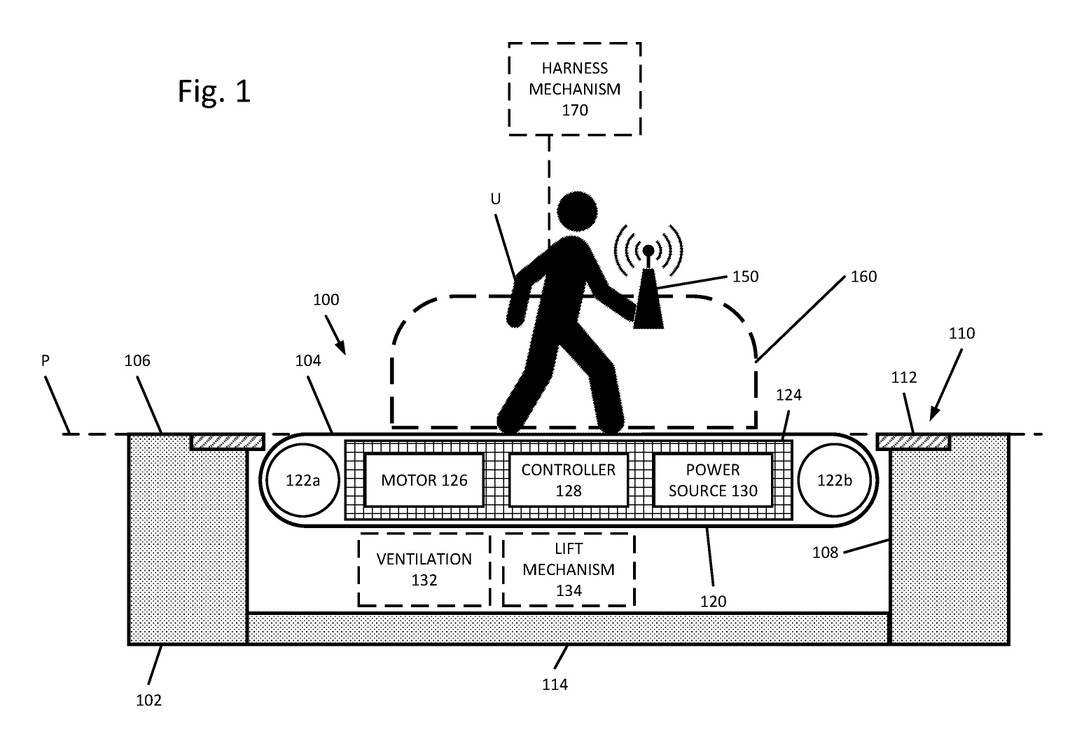

FIG. 1 is a schematic illustration of a treadmill assembly 100, which in one embodiment can be seamlessly integrated into a surrounding floor 102 to be level or below the floor 102 for improved aesthetics. In particular, an upper, planar surface 104 of the treadmill assembly 100 is co-planar with an upper, planar surface 106 (defined by a plane P) of the floor 102.

In another embodiment, the planar surface 104 is either slightly above or slightly below (e.g., within approximately one inch) plane P. The assembly 100 can be installed in various locations such as condos, homes, fitness clubs, cruise ships, spas, hotels, workplaces, clinics, airports, shopping malls, public spaces and others. When upper surface 104 is positioned substantially co-planar or coplanar with plane P, risk of injury due to tripping and/or falling is greatly reduced. If full concealment of the treadmill assembly 100 is desired, the assembly 100 would be recessed deeper than plane P such that a door or other surface could be mounted above the treadmill assembly 100. The door or other surface could be the same or similar surface as the floor surface 106. A sliding door which is concealed within the floor on either side of the treadmill could permit the surface 104 and assembly 100 to be concealed under the sliding door. In one embodiment, the treadmill assembly 100 is installed within an opening (or cavity) 108 in floor 102. The opening 108 can be sized to house the treadmill assembly 100 and any additional components of the treadmill assembly 100, as discussed below. To improve aesthetics and prevent injury, an edge assembly 110 is provided that surrounds the treadmill assembly 100 and substantially reduces a gap created between the opening 108 and the treadmill assembly 100.

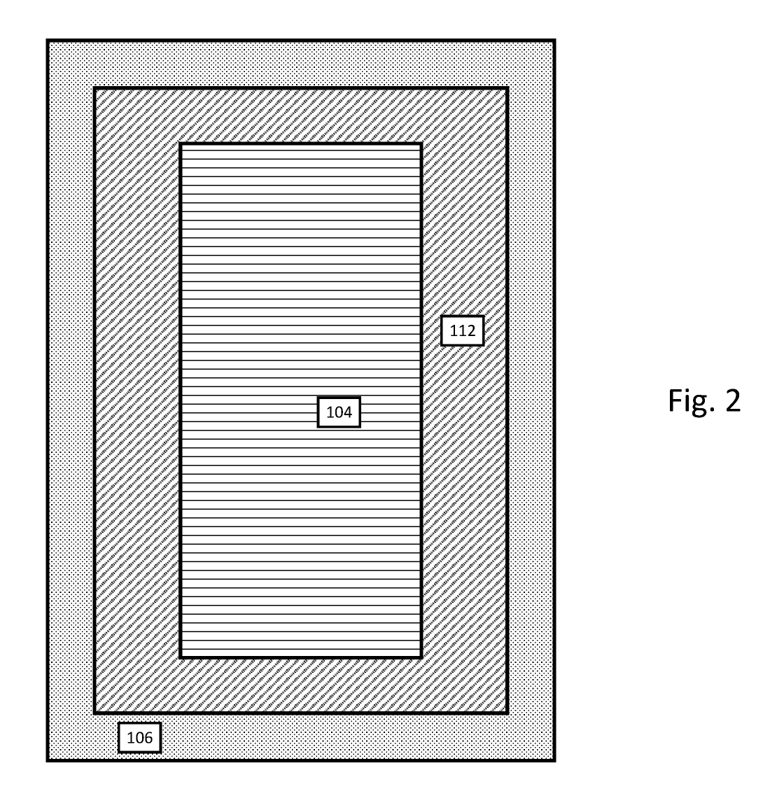

As illustrated in the top view of FIG. 2, upper surfaces 104, 106 and 112 are all substantially coplanar so as to reduce tripping such that each of the surfaces 104, 106 and 112 appear to be a single, continuous surface. The treadmill assembly 100 can be supported by the floor 102. For example, the treadmill assembly 100 can be supported by a lower structure 114 of the floor 102 or through a supporting mechanism (e.g., a support that spans across opening 108). The edge assembly 110 can be formed of one or more pieces and positioned such that an upper surface 112 of the edge assembly 110 is coplanar or substantially coplanar with plane P. In one embodiment, the edge assembly 110 is formed of a single panel with an opening that accommodates the treadmill assembly 100 and is coupled with the floor 102. In another embodiment, the edge assembly 110 includes singular pieces that pivot (e.g., with a hinge) or otherwise move relative to the floor 102 (while maintaining connection thereto) to accommodate installation, removal and/or maintenance of the treadmill assembly 100. In a further embodiment, the edge assembly 110 can be integrated into the treadmill assembly 100 such that an entire unit including the treadmill assembly 100 and edge assembly 110 can be positioned within the opening 108 of the floor 102. The edge assembly 110 can be positioned to cover at least a portion of the opening 108. In one embodiment, the edge assembly 110 covers side rails of the treadmill assembly such that the belt is solely exposed to the opening while the side rails remain covered. In a further embodiment, the edge assembly 110 covers the treadmill assembly such that the edge assembly needs to be removed prior to removing the treadmill assembly 100 from the opening.

A user U can operate the treadmill assembly 100 such that the user U can walk and/or run in place. The treadmill assembly 100 includes a belt 120 that surround and are coupled with opposed rollers 122a and 122b. A support frame 124 houses a motor 126, controller 128 and power source 130. The motor 126 is operatively coupled with the rollers 122a and 122b to drive the belt 120 during operation in either direction. The controller 128 controls operation of the motor 126 and is coupled with the power source 130 to selectively provide control signals and power to the motor 126. Optionally, the treadmill assembly 100 can also include ventilation 132 (e.g., including openings and/or a fan) to provide ventilation to components housed within the support frame. Additionally, the treadmill assembly 100 can include a lift mechanism 134 that operates to move the support frame 124 (and thus the belt 120 and associated components 126, 128 and 130) relative to the floor 102. To this end, the lift mechanism 134 can create an incline for the belt 120 to simulate the user U walking/running up a hill. In addition, the lift mechanism 134 can move the support frame 124 relative to the floor 102 such that the treadmill assembly 100 can be serviced as needed. The lift mechanism can be manually powered (e.g., through a crank) or powered by a motor (e.g., an electric or pneumatic motor). The treadmill assembly 100 can further include “plug-in” componentry for ease of servicing, which could permit the belt 120, motor 126, controller 128, or other component piece to be quickly and easily swapped out to avoid lengthy on site servicing and thus minimize disruption to owners.

In a further example, access to the assembly 100 can be performed from below floor 102. In this example, portion 114 can include an access door or other mechanism to accommodate access to treadmill assembly 100. The user U can control operation of the treadmill assembly 100 wirelessly (e.g. through Wi-Fi, Bluetooth or other suitable wireless communication means) or through direct communication with the controller 128. For example, the user U can communicate with controller 128 through a device 150 such as a mobile device (e.g., through an application on a phone, key fob), which can move the belt 120 relative to the frame 124 in either direction and at varying speeds. As such, the user U can face in either direction as the belt 120 moves. The user U may also control the treadmill assembly 100 through voice commands, through a switch mounted in close relation to the treadmill assembly 100 or through other means. Control of the treadmill assembly 100 can include a preset speed (e.g., 1.4 miles per hour) in general or for a particular individual. As such, the user U can have an “instant on” feature to start treadmill assembly 100 where one version would be a wall switch, button or other activation device/switch in close proximity to assembly 100. This device, switch or button could restrict access by requiring a password, biometric credential or other access feature to prevent unauthorized users or inadvertent activation and/or operation. An individual can change this preprogrammed speed by simply accessing and then changing the controller 128 to reflect a new desired speed, for example through device 150.

In one embodiment, rails 160 can be attached to the treadmill assembly 100 to provide support for the treadmill user U. These optional rails can include “pop-in” rails which conveniently snap in place through a suitable coupling mechanism such as a pin/slot arrangement. In one example, the coupling mechanism would include thin slots (approximately 6 inches to 12 inches in length) on a bottom of each rail that snap into receiver slots, which are discretely placed just outside the edge assembly 110 and between the floor surface edging (e.g., carpet, tile, wood) and the upper surface 104. The slots would be of sufficient height to permit stabilization to the rails. In another embodiment, the rails 160 would be telescoping handrails having a non-deployed state wherein the rails 160 are recessed proximate or below plane P and a deployed state wherein the rails are extended and locked to provide stable support to the user U. In addition to the rails 160, or independent therefrom, a harness mechanism 170 can be employed, which can be secured to the user U and at another support point (e.g., a ceiling). In one example, the harness mechanism 170 can include a vest worn by the user U and attached through a cabling system to the ceiling within the room. The harness mechanism 170 can be set to a particular tolerance of movement to restrict the user U from falling or otherwise exiting a desired range of movement.

One alternative embodiment of treadmill assembly 100 is to alter belt 120 and/or support frame 124 to have a desired surface density and landing resistance. For example, the surface density could match the adjacent floor density. Alternatively, the surface density could be modified to closely resemble grass so as to more closely emulate walking or running outdoors and in a natural setting. In a further embodiment, surfaces 106 and 112 can be made from a rubberized or otherwise soft material with reduced density to increase the safe operation of the device in the instance where a user might fall, stumble, trip or otherwise come into forceful contact with an area surrounding the treadmill assembly 100 or its parts. In other variants, a width of a belt could be extended to accommodate multiple users (e.g., couples desiring to walk together or for an owner to walk next to his pet). Other options include a built in concealed screen monitor that comes out from the floor 102 and deploys in front of treadmill assembly 100 for watching videos and/or interacting with the screen while walking or running. Further still, another variation includes a shelf window with a concealed computer device.

Another option permits integration of this unit with either virtual or augmented reality capability or other emerging technology which would allow an operator of the unit while walking, running, jogging or otherwise moving on the treadmill in operation to experience visual stimulus and feedback to improve, enhance, augment or otherwise contribute to the level of experience and enjoyment of the treadmill assembly 100. The treadmill assembly 100 could be integrated into existing virtual/augmented reality systems who desire the unique and desirous attributes of a flat moving surface which is nearly or could be made completely concealed from view. In one embodiment, users can select a computer generated walk anywhere in the world which would take place anywhere in conjunction with treadmill assembly 100 by using a virtual/augmented reality system or some other similar reality simulating technology.

In another embodiment, an image can be generated and displayed which could be superimposed on or within the virtual or augmented reality system or other type of media simulating reality imagery so as to provide the user moving on the treadmill assembly 100 a useful reference to be able to discern their actual physical relationship to the treadmill assembly 100 and its adjoining surface. As such, the user is provided with an point of reference to the associated physical reality while using a virtual/augmented or other media simulating reality technology. Such a superimposed reference point can be computer generated and show a user physical features imposed onto the camera image.

Another version includes a snap in desk or mount for a desk/shelf or other item to connect proximally to assembly 100 by snap-in mechanism into anchoring slots which are either slots, screw in anchors or other method of secure attachment located within, below or part of edge assembly 110. In a further embodiment, the treadmill assembly 100 can be installed into a rotating deck which rotates in both directions to essentially permit the treadmill to be rotated in any position so that user U can rotate treadmill assembly 100 to face any direction they desire. This rotational deck may be either manually operated by crank or human powered handled grip. In another embodiment, the rotating deck could be powered by motorized unit to permit easy motorized rotation of the treadmill surface to the exact desired position within the floor. Rotation of the deck could be operated by either a separate device or device 150 which operates the treadmill assembly 100.

In one version of the treadmill assembly 100, the motor 126 is restricted to operating belt 120 at walking speeds and therefore not intended for running. As such, the length and/or width of the treadmill assembly 100 can be substantially reduced by 20 to 80% compared with conventional treadmills that operate at higher speeds. This reduced length would offer an advantage in spatial requirements and aesthetics over such conventional treadmills.

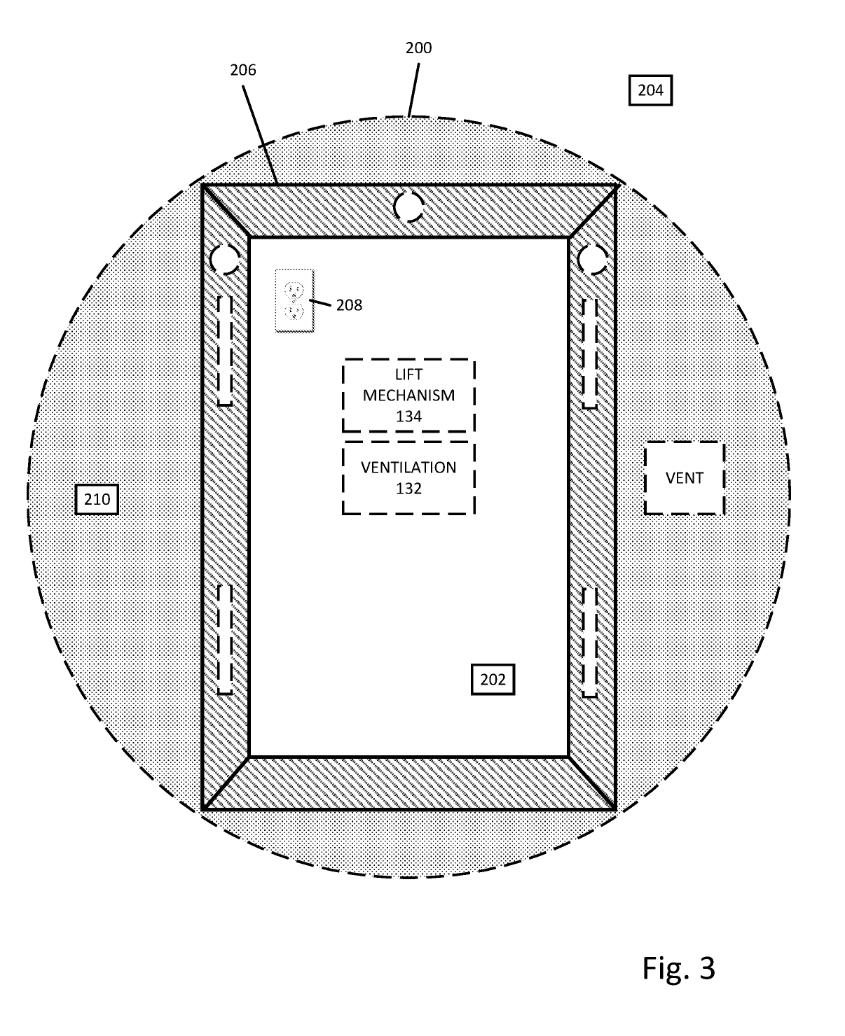

Another embodiment of the concepts presented herein is a frame assembly 200 illustrated in FIG. 3 which is capable of being mounted within a floor space. The frame assembly 200 includes a central cavity 202 sized to receive a treadmill such that a belt of the treadmill can be integrated into an existing floor surface 204 so as to diminish or eliminate tripping, falling or injury risks which now exists with conventional designed treadmills and furthermore improve aesthetic appearance of a treadmill otherwise resting on top of a floor. The frame assembly 200 includes an edge assembly 206 surrounding the central cavity 202. In one embodiment and as illustrated in dashed lines within edge assembly 206, anchor points, slots, or grooves can be provided into which “pop-in” handrails could be easily inserted, if desired by as well as an anchoring point(s), slot(s), or other mechanism to attach, mount, or support a desk, or work surface or any other desirable feature which a user or owner may want to combine, attach to frame assembly 200.

A suitable power outlet 208 can also be provided within cavity 202 so as to provide power to a treadmill installed within cavity 202. The frame assembly 200 can also contain ventilation 132 as discussed above, further equipped as desired with a fan and suitable conduit/vent to allow dissipation of heat which might otherwise occur from a motorized treadmill being installed within cavity 202. The frame assembly 200 can also include a lift mechanism 134 as discussed above. In one embodiment, the lift mechanism 134 is a manual lift system incorporated within it which is engaged by insertion of a hand crank or turning device which might be a handle, wheel or other device inserted securely into a receiving port within the frame assembly 200 wherein, when manually turned, cranked or engaged causes a sliding portion of the lift mechanism 134 to slide up in a controlled, secure manner when twisting, cranking or other suitable forces are manually applied so as to raise and lift up a treadmill. The lifting allows for positioning of the treadmill relative to the flooring, servicing of the treadmill or access otherwise to the underside otherwise concealed portions or areas of the integrated treadmill (or other similar pieces of equipment whose design or operation is improved by flat flush mounting within a floor surface) or to additionally access cavity 203 under the treadmill into which the assembly frame has been installed.

A receiving anchoring port for this crank/turning device can be obscured from sight by being concealed below edge assembly 206. Edge assembly 206 can be a part of the frame assembly 200 and rotate up 45-180 degrees to allow access to the lift mechanism 134. Further still, another embodiment of frame assembly 200 allows for a motor unit of sufficient power output to allow for powered, controlled and secure lifting of the treadmill in cavity 202 to permit positioning of the treadmill relative to the flooring, access to concealed areas of the treadmill or access to the cavity 202. One other version of the frame assembly 200 would also allow for integration within a turn-deck 210 to allow for easy rotation of the frame assembly 200 (and contained treadmill within cavity 202) to permit positioning within a room or area with ease. This frame assembly 200 overcomes additional costs resulting from a manufacturer from having to modify existing treadmill designs to incorporate the above desirable features required to permit flush mounting, installation and operation of a treadmill or other equipment whose operation or performance is enhanced by flush level installation within floor 204.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A system including a treadmill assembly positioned within a cavity of a surrounding floor, the treadmill assembly having an upper surface defining a plane that is proximate to an upper surface of a surrounding floor and an edge assembly covering a portion of the cavity and positioned between the surrounding floor and the treadmill assembly.

2. The system of claim 1, further comprising a lift mechanism that operates to move the treadmill assembly above the upper surface of the surrounding floor.

3. The system of claim 1, further comprising a device in wireless communication with the treadmill assembly for operating the treadmill assembly.

4. The system of claim 1, wherein the edge assembly covers the opening on four sides of the treadmill assembly.

5. The system of claim 1, further comprising an image generation device operating in conjunction with the treadmill assembly such that images shown to a user change along with operation of the treadmill assembly.

6. The system of claim 5, wherein the image generation device is a virtual reality device.

7. The system of claim 1, further comprising ventilation positioned within the cavity and below the treadmill assembly.

8. The system of claim 1, further comprising a power source positioned within the cavity.

9. The system of claim 1, further comprising apertures in the edge assembly configured to receive rails to be grasped by a user.

10. The system of claim 9, further comprising rails positioned within the apertures.

11. The system of claim 9, further comprising a desk positioned to be accessed by a user that is on the treadmill assembly.

12. The system of claim 1, further comprising a frame assembly defining the cavity and positioned within the surrounding floor, the frame assembly being positioned to rotate relative to the surrounding floor.

13. The system of claim 1, wherein a surface density of the treadmill assembly is approximately the same as a surface density of the surrounding floor.

14. The system of claim 1, wherein a surface density of the treadmill assembly is less than a surface density of the surrounding floor.

15. The system of claim 1, further comprising a harness configured to support a user on the treadmill assembly.
